(19) United States
(12) Patent Application Publication
(10) Pub. No.: US 2015/0271879 A1
(43) Pub. Date: Sep. 24, 2015

(54) DEVICE AND METHOD FOR THE PROCESS-BASED POWER CONTROL OF AN ELECTRIC ARC FURNACE

(71) Applicant: MASCHINENFABRIK REINHAUSEN GMBH, Regensburg (DE)

(72) Inventors: Klaus Krueger, Saaldorf-Surheim (DE); Dieter Dohnal, Lappersdorf (DE); Karsten Viereck, Regensburg (DE); Alexei Babizki, Regensburg (DE)

(21) Appl. No.: 14/428,792

(22) PCT Filed: Oct. 9, 2013
(86) PCT No.: PCT/EP2013/071030

§ 371 Date: Mar. 18, 2015

(30) Foreign Application Priority Data
Oct. 16, 2012 (DE) 10 2012 109 847.6

(51) Int. Cl. H05B 7/144; G05F 1/20

(52) U.S. Cl. CPC H05B 7/144; G05F 1/20

(57) ABSTRACT

Disclosed are an apparatus and method for process-based power regulation of an electric arc furnace (10). A plurality of sensor types (15, 16, 17) detect presently active operating parameters of the electric arc furnace (10) in dependence on time. From the measured values, a control and regulating unit (30) determines the necessity of whether to switch other winding taps (T_{S1} . . . T_{SN}) of the primary side (6P) of the furnace transformer (6) by a semiconductor tap changer (20) in order to effect a modified electrical power to prevent thermal and/or mechanical damages to the electric arc furnace (10).

The invention relates to an apparatus for process-based power regulation of an electric arc furnace. In particular, the apparatus provides a plurality of sensor types for the purpose of detecting presently active operating parameters of the electric arc furnace in dependence on time. The presently active operating parameters are transmitted to a control and regulating unit, and a corresponding regulation algorithm calculates the required regulation. The regulation of the electric arc furnace is carried out by at least one furnace transformer. The control and regulating unit co-acts with at least one on-load tap changer, with the winding taps on the primary side of the furnace transformer being switchable by an on-load tap changer. Three electrodes are electrically connected with the secondary side of the at least one furnace transformer and they are respectively arranged in one line.

The invention further relates to methods for thermally based power regulation of an electric arc furnace.

The German patent specification DE 35 12 189 [U.S. Pat. No. 4,683,577] discloses a method and an apparatus for regulating electric arc furnaces. The purpose is to enable precision adjustment of the electric arc voltage and the electrode height in a manner that is economical and technically feasible without great effort. The actuator of the electrode height is always controlled by a current regulation loop (or impedance control loop) that a power regulation loop is superimposed on in the instance of a power regulation. Besides providing the transformer stage, the power regulator superimposed on the current regulator also provides the reference variable for the current regulator, as the case may be. In all cases, only the current regulator acts directly on the electrode adjustment. For the tap changer drive used for the transformer, this therefore results in the possibility to either feed the transformer voltage, which is adjustable by the tap changer, directly via an operation diagram or to adjust it by the mentioned power regulator. The lift drive for the electrodes is controlled via the current regulator.

The European patent application EP 2 362 710 [US 2012/0320942] discloses an electric arc furnace and a method for operating an electric arc furnace. The electric arc assigned to the at least one electrode has a first radiant power that results on the basis of a first adjusted set of operating parameters. The electric arc furnace is operated according to a specified operation program that is based on an expected process sequence. Monitoring is conducted as to whether there is an undesired deviation between the actual process sequence and the expected process sequence. If there is a deviation, a modified second radiant power is specified. By means of the second radiant power, a modified second set of operating parameters is determined. The method allows to achieve an as short as possible smelting duration while protecting the operating means, in particular the furnace vessel.

The German patent application DE 35 43 773 [U.S. Pat. No. 4,689,800] describes a method for operating an electric arc furnace such that it is possible with fluctuating raw materials to smelt this material at a minimum value of the drawn electrical energy consumption. The furnace transformer is provided with a load switch, thus making it possible to adjust the output voltage at the secondary side of the transformer. The control is carried out by changing the taps of the furnace transformer or by adapting the current operating point, both being carried out for modifying the length of the electric arc. The electric current flowing from the secondary side of the furnace transformer to the arc electrode is measured in the process. If the electric arc furnace is operated with an electrical operating point that is regulated in this manner, then the electrical energy consumption is lowered in the smelting process and the drawn electrical energy consumption can be kept at a minimum.

The German patent application DE 10 2009 017 196 [U.S. Pat. No. 8,624,565] discloses a tap changer with semiconductor switching components for uninterrupted switching between fixed tap changer contacts that are electrically connected with winding taps of a tapped transformer. In this context, each of the fixed tap changer contacts is either directly connectable with a load dissipation or, during switchover, connectible via the interconnected semiconductor switching components. The load dissipation has fixed, divided dissipation contact pieces so that the semiconductor switching components are galvanically isolated from the transformer winding during stationary operation. There are, however, various disadvantages to tap changers with semiconductor switching components. The permanent application of operating voltage and the strain on the power electronics by lightning impulse voltage necessitate large isolation distances, which are not desirable.

As known from the prior art, the electrical components for controlling or regulating the operation of an electric arc furnace are a furnace transformer, a choke coil, and an electrode support arm system. The energy supply for the alternating current electric arc furnaces is carried out via furnace transformers with an integrated tap changer. The corresponding energy input can be adjusted by the transformer stages.

A choke coil that is switchable under load and connected upstream of the transformer, serves for regulating the reactance of the current circuit and thus enables operating the furnace with stable electric arcs as well as limiting the short circuit current. The suitable stage is selected both for the transformer and for the series-connected choke in dependence on process progress. This can be effected by manual intervention from the furnace operator, by an integrated control, or by regulation.

In manual control, an experienced furnace operator can assess the process by the sound emission from the furnace and the appearance of the melting material. The transformer stage is adapted in critical situations (for instance, a free-burning electric arc).

In automatic control, the transformer stages and the choke stages, as the case may be, are adapted depending on the energy being presently input. In order to maintain the electric arc as stable as possible, a high inductance is generally required in the initial “drilling phase” (OLTC choke==highest stage). The series-connected choke is switched off in the last phase “liquid bath” in order to reduce the reactive power.

A lower voltage step (short electric arcs) is selected during the drilling phase to protect the refractory lining of the furnace (the refractory) as well as the furnace lid. After the electric arc has been covered in foaming slag, the highest voltage step is selected to achieve the highest energy input into the melt. To ensure the high energy input during the last phase, a slightly lower step voltage is selected, while using the maximum current setting.

In particular in the manual and automatic control processes, the above mentioned specifications only very inadequately measure up to the actual process state. Even the newest regulations are also not able to react with the appropriate time constants (for example in the range of milliseconds) to the quick changes in the system.

With regard to tap changers in furnace transformers and choke coils and depending on the diverse switching strategies of the customers, the high switching frequencies are regarded as a technical stress factor. This is primarily attributed to contact erosion and to wear of the mechanical components in the tap changers.

Maintenance works on tap changers normally imply a high effort and, above all, cost-intensive production downtime, making it definitely desirable for the operator to extend the maintenance interval in order to reduce the maintenance effort for the tap changer as much as possible.

The object of the invention is to create an apparatus for process-based power regulation of an electric arc furnace, which apparatus makes it possible to intervene in process changes in the electric arc furnace with the appropriate time constants (in the range of milliseconds) and at the same time to reduce the down times of the electric arc furnace and to extend the maintenance intervals for the tap changers.

The object is solved by an apparatus for process-based power regulation of an electric arc furnace comprising the features of claim 1.

A further object of the invention is to create a method for process-based power regulation of an electric arc furnace, which method makes it possible to intervene in process changes in the electric arc furnace with the appropriate time constants (in the range of milliseconds) and at the same time to reduce the down times of the electric arc furnace and to extend the maintenance intervals for tap changers.

The object is solved by a method for process-based power regulation of an electric arc furnace comprising the features of claim 5.

The apparatus according to the invention for process-based power regulation of an electric arc furnace is characterized in that the on-load tap changer is a semiconductor tap changer.

According to a possible embodiment, each electrode can be assigned a furnace transformer, of which the winding taps of the primary side are switchable by respectively one semiconductor tap changer, wherein the secondary side of each furnace transformer is connected with the electrode.

The sensor types used for determining the regulation parameters or measurands are thermal sensors and/or optical sensors and/or acoustic sensors and/or structure-borne sound sensors. All sensors are connected with the control and regulating unit.

The control and regulating unit is communicatively connected with the semiconductor tap changer such that the voltage presently applied at the electrodes is regulatable in dependence on the measurands of the sensor types and in comparison with a set point.

The method according to the invention is characterized in that:

by means of a plurality of sensor types, presently active operating parameters of the electric arc furnace are detected and transmitted to a control and regulating unit, by means of which a criticality value is determined; and

in that a switching of taps at a primary side of at least one furnace transformer is influenced by at least one semiconductor tap changer in dependence on the determined criticality value in such a manner that the state of the electric arc furnace is kept in an uncritical operating state or brought into an uncritical operating state.

Normally, the electric arc furnace has three electrodes, by means of which thermal energy is input into the electric arc furnace. The electrodes are connected with a secondary side of the furnace transformer so that a modified voltage is applied to three secondary lines via the switching of the taps on the primary side of the furnace transformer. According to one embodiment of the method, the electrodes are supplied symmetrically with a required amount of electrical energy so that the state of the electric arc furnace is kept in an uncritical operating state or brought into an uncritical operating state.

According to a further embodiment of the method according to the invention, an asymmetrical voltage is applied to the phase conductors of the electrodes by the semiconductor tap changer. The three secondary lines are thus supplied asymmetrically with a required amount of electrical energy so that the state of the electric arc furnace is kept in an uncritical operating state or brought into an uncritical operating state. Asymmetrically adjustable phase voltages are required for this purpose. In terms of amount, the applied voltages at the individual electric arcs typically differ by up to 10%.

Normally, the electric arc furnace has three electrodes, by means of which thermal energy is input into the electric arc furnace. Each of the electrodes is connected with a secondary side of a furnace transformer assigned to it, and the electric arcs are supplied with an appropriate amount of energy by the switching of the taps on the primary side of the respective furnace transformer. The energy input is formed in such a manner that the state of the electric arc furnace is kept in an uncritical operating state or is brought into an uncritical operating state. Each of the electric arcs is controllable independently of the other electric arcs of the electric arc furnace.

The criticality value is calculated from the operating parameters of the electric arc furnace, which operating parameters are composed of the thermal state of a vessel of the electric arc furnace and/or an optical detection of burning electric arcs and/or the sound or structure-borne sound emitted from the electric arc furnace.

The regulation of the electrical quantities in electric arc furnaces is carried out in two areas. The superordinate process control system specifies the secondary phase voltage (the transformer stage, respectively) and the current set point. The subordinate electrode regulation regulates the current by the electric arc lengths and thus ensures that the specified set point is on average maintained. The present invention relates to the superordinate process control system, thereby taking into account the regulation of the phase voltages.

The process state of the electric arc furnace is or free-burning electric arcs are detected in the first step. This can be carried out by temperature measurements, structure-borne sound measurements, or radiation measurements. Based on the measured values, the so-called criticality value can be determined in the next step. The criticality value is given as a percentage and describes the present state of the smelting process. At 0%, the state is not critical. The highest stage is 100% and the state of the smelting process is extremely critical. The power of the electric arc furnace is now being regulated in dependence on the present criticality value. If the criticality value is, for instance, in the range of 0 to 30%, the maximum power continues to be applied to the electric arc furnace. If the criticality value is, for instance, between 30% and 60%, the power is linearly reduced. From a criticality value of 60%, the power is adjusted to the lowest setting.

The new regulation specifically prevents the hot spots responsible for refractory wear, thus achieving a better protection of the operating means, by using the line-specific regulation via asymmetrical phase voltages as a regulating variable to extend the regulation algorithm.

Asymmetrical power regulation is understood to mean an asymmetrical modification of the phase voltages. In the semiconductor tap changer, the required adjustment range for the voltage asymmetry should be approximately ±10%. The frequency is in the range of 1 second.

These and other features and advantages of the various disclosed embodiments set forth here will be more fully understood with reference to the following description and the drawings, throughout which the same reference characters designate the same elements, and in which:

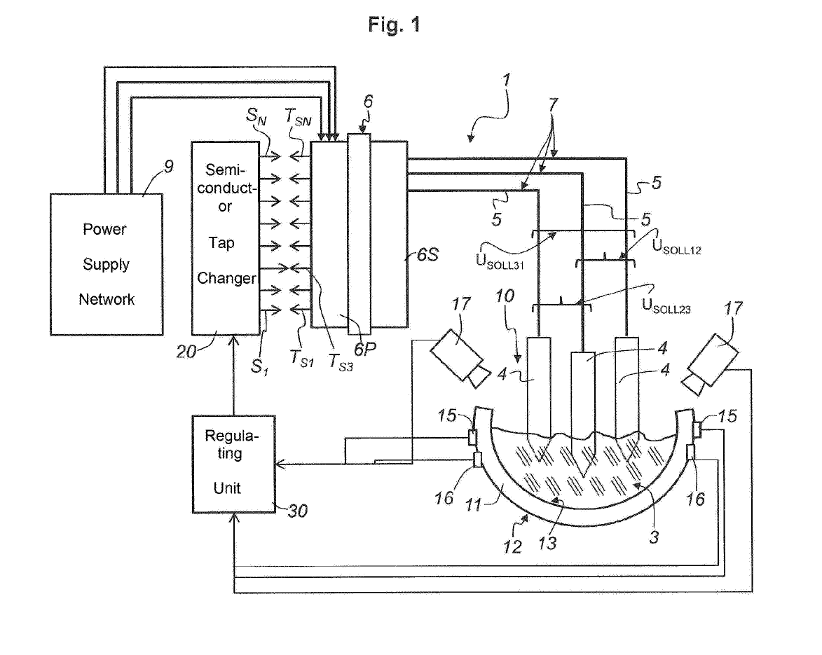

FIG. 1 shows a schematic presentation of a system for smelting metal by means of an electric arc furnace;

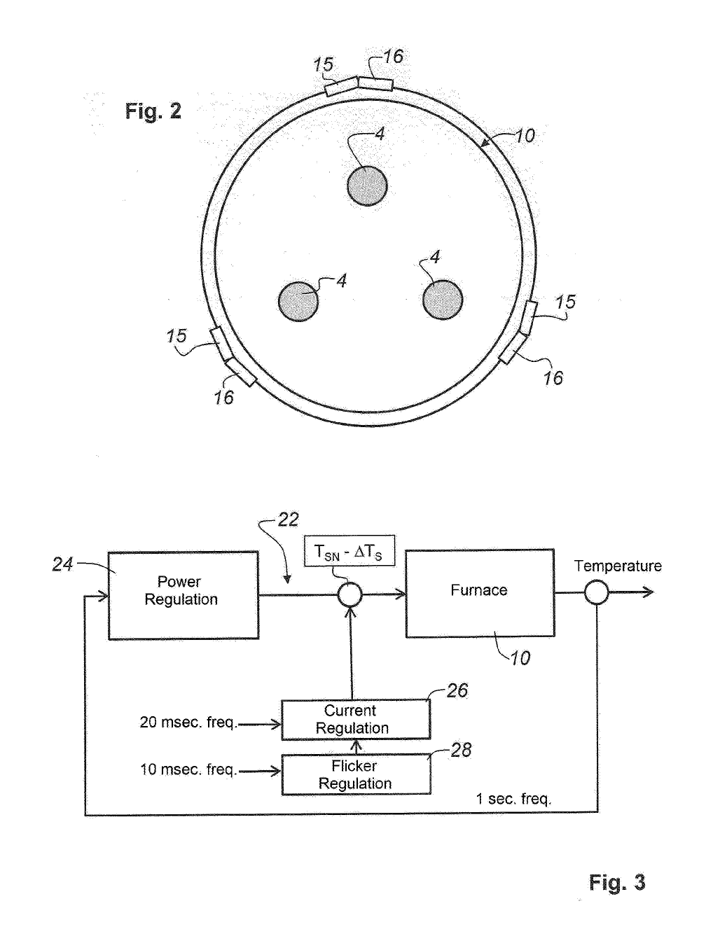

FIG. 2 shows a schematic view of the spatial arrangement of the electrodes in the electric arc furnace and of the assignment of sensors to the electrodes;

FIG. 3 shows a schematic presentation of the integration of the thermally based power regulation into the overall regulation of the electric arc furnace;

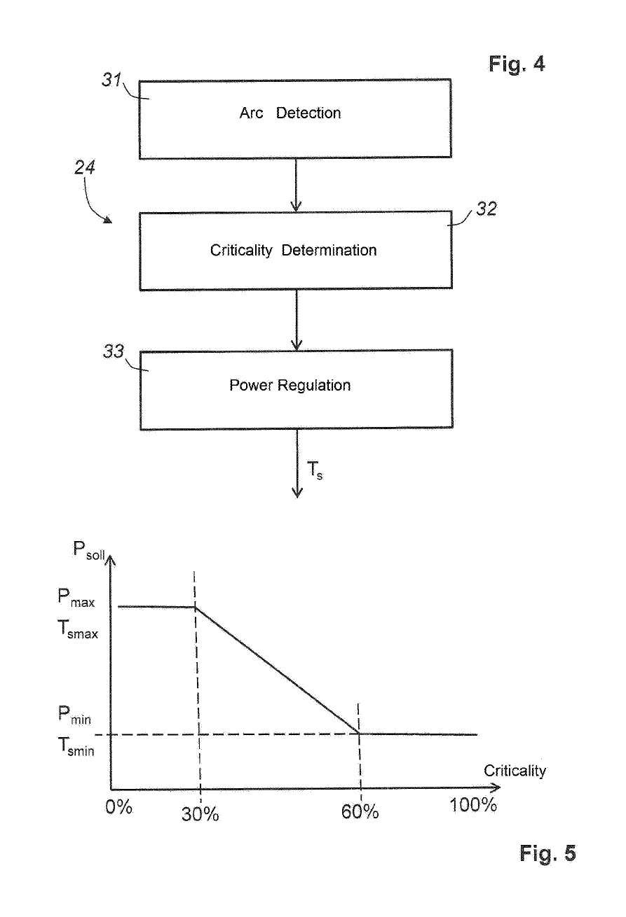

FIG. 4 shows a schematic view of the flowchart of the thermally based power regulation of the electric arc furnace; and

FIG. 5 shows a presentation of the functional connection of the criticality value and the presently active power.

FIG. 1 shows a schematic presentation of a system 1 for smelting metal by means of an electric arc furnace 10. The electric arc furnace 10 is composed of a furnace vessel 11, in which steel scrap is smelted and a melt 3 is produced. The furnace vessel 11 can additionally be provided with a lid that is not illustrated. Wall 12 and lid are provided with a water cooling system. In dependence on the operating mode of the electric arc furnace 10, the furnace has one or three electrodes 4. One electrode 4 is used in a direct current electric arc furnace. Three electrodes 4 are used in an alternating current electric arc furnace 10. The following description illustrates the principle of the invention as exemplified by an alternating current electric arc furnace. A refractory material, which is not illustrated, lines an inner wall 13 of the electric arc furnace 10.

The electrodes 4 are arranged on a support arm, which is not illustrated, and they can be inserted into the furnace vessel 11 as required. Each of the electrodes 4 is equipped with a phase conductor 5 that is connected with a secondary side 6S of a furnace transformer 6. The phase conductor 5, the electrode 4, and the electric arc, which is not illustrated, thus form a phase or a line 7 of the alternating current circuit. A primary side 6P of the furnace transformer 6 is supplied with the required high voltage from a power supply network 9. An on-load tap changer 20 that is constructed as a semiconductor tap changer, is connected with the primary side 6P of the furnace transformer 6.

A control and regulating unit 30 co-acts with the semiconductor tap changer 20 to switch taps of the furnace transformer 6 on the primary side 6P in such a manner that the taps are supplied with a corresponding phase voltage and corresponding current such that the electric arc furnace 3 works within a specified target range. The primary side 6P of the furnace transformer 6 has a plurality of winding taps T_{S1} . . . T_{SN} that are switched by the semiconductor switching components S1 . . . SN of the semiconductor tap changer 20. The control and regulating unit 30 receives input from a plurality of sensor types 15, 16, and 17 that are assigned to the electric arc furnace 10. From the input data, the control and regulating unit 30 determines the switching sequence of the semiconductor tap changer 20 and the required switching of the winding taps T_{S1} . . . T_{SN}, of the secondary side 6S of the furnace transformer 6 such that the electric arc furnace 10 works within a specified range of the furnace power.

For this purpose, the plurality of sensor types 15, 16, and 17 detect the thermal state of the electric arc furnace 10. The sensor types 15, 16, and 17 are constructed as thermal sensors 15 and/or optical sensors 17 and/or acoustic sensors 16 and are connected with the control and regulating unit 30. The present thermal state of the electric arc furnace 10 can be detected by temperature measurements, structure-borne sound measurements, or radiation measurements. A temperature sensor, for instance that measures the temperature of the cooling water, for instance, and thus allows a conclusion on the present thermal load, can be used for temperature measurements. Structure-borne sound measurements can be carried out by acoustic sensors, where the measurement results also allow conclusions on the temperature development in the electric arc furnace 10. Cameras, for instance, can be used for radiation measurements such that these also allow conclusions on the temperature development in the electric arc furnace 10. The control and regulating unit 30 determines a criticality value from the gathered data. In dependence on the value of the determined criticality, a switching of winding taps T_{S1} . . . T_{SN} at a primary side 6P of at least one furnace transformer 6 is influenced by at least one semiconductor tap changer 20 in such a manner that the state of the electric arc furnace 10 is kept in an uncritical operating state or brought into an uncritical operating state.

In FIG. 2, a schematic view of the spatial arrangement of the electrodes 4 in the electric arc furnace 10 and the spatial assignment of the thermal sensors 15 and the acoustic sensors 16 to the electrodes 4 is illustrated. In the embodiment presented here, the electric arc furnace 10 has three electrodes 4, by means of which thermal energy is input into the electric arc furnace. The electrodes 4 are arranged in the shape of a triangle. A thermal sensor 15 and an acoustic sensor 16 are spatially assigned to each electrode 4 such that the individual thermal state of the electric arc furnace 10 can be detected in the area of each electrode 4. Asymmetrical phase voltages U_{SOLL12}, U_{SOLL23}, or U_{SOLL31} can thus be applied to the phase conductors 5 of the electrodes 4 such that the electrodes 4 are asymmetrically supplied with a required amount of electrical energy.

FIG. 3 renders a schematic illustration of the integration of the process-based power regulation into the overall regulation 22 of the electric arc furnace 10. The overall regulation of the electric arc furnace 10 is ultimately realized via the semiconductor tap changer 20. The process-based power regulation 24 works at a frequency in the range of 1 second. The over current regulation 26 works at a frequency in the range of milliseconds. The flicker regulation 28 works at a frequency in the range of 10 milliseconds. The frequency for each of the regulations corresponds to the repetition rate of the corresponding regulations. As a result of the measurements, it is possible by means of the semiconductor tap changer 20 to switch over to the appropriate winding tap T_{S1} . . . T_{SN} on a primary side 6P of the furnace transformer 6 for carrying out the required regulation of the electric arc furnace 10.

FIG. 4 renders a schematic view of the flowchart of the thermally based power regulation of the electric arc furnace 10. The process state 11 and, in particular, free-burning electric arcs are detected in the first step 31. This can be carried out, as already mentioned above, with a plurality of sensor types 15, 16, and 17. The sensor types 15, 16, and 17 are constructed as thermal sensors 15 and/or optical sensors 17 and/or acoustic sensors 16 and are connected with the control and regulating unit 30. Temperature measurements, structure-borne sound measurements, and/or radiation measurements can thus be carried out. Based on the measured values, a so-called criticality value can be determined in the second step 32. The criticality value is given as a percentage and describes the present state of the smelting process. The state is not critical at 0%; at 100%, the highest stage is reached, and it is absolutely required to modify the power of the electric arc furnace 10. In a third step 33, the power of the electric arc furnace 10 is then regulated in dependence on the present criticality value. For this purpose, the thermal inertia of the furnace vessel 11 of the electric arc furnace 10 is to be taken into account. The percentage values or percentage ranges of the criticality value that require intervention from the semiconductor tap changer 20 can be determined by the operator of the electric arc furnace 20.

FIG. 5 shows a presentation of the functional connection of the criticality value and the presently active power P in the electric arc furnace 10. If the criticality value is, for instance, between 0 and 30%, no regulation is required and the electric arc furnace 20 can be operated at the maximum power Pₘₐₓ. If the criticality value is, for instance, between 30% and 60%, a linear reduction of the active power P can be, for instance, carried out. If the criticality value is, for instance, above 60%, the electric arc furnace 10 will be set to a minimal power Pₘᵢₙ. By realizing the regulation algorithm in interaction with the semiconductor switch 20, a line-specific regulation can be carried out via the phase voltages U_{SOLL12}, U_{SOLL23}, or U_{SOLL31} as regulating variable. With the semiconductor switch 20, it is possible to perform quick switching and to skip more than one winding taps (T_{S1} . . . T_{SN}) on the primary side 6P of the furnace transformer 6. Thus, the phase voltages U_{SOLL12}, U_{SOLL23}, and U_{SOLL31} that are required for the regulation, are applied to the lines 7, whereby a better protection of the operating means is achieved, because the hot spots responsible for the refractory wear are specifically prevented by the new, quick, and variable regulation.

With the semiconductor switch 20, the regulation of the power of the electric arc furnace 10 can be carried out symmetrically or asymmetrically. Asymmetrical power regulation of the electric arc furnace 10 is understood to mean a non-asymmetrical modification of the regulated phase voltages U_{SOLL12}, U_{SOLL23}, and U_{SOLL31} at the lines 7. In the semiconductor switch 20, the required adjustment range for the asymmetry of the phase voltages U_{SOLL12}, U_{SOLL23}, and U_{SOLL31} between the lines 7 of the semiconductor switch 20 should be approximately up to ±10%. As already mentioned, the frequency in this context is in a range of 1 second.

The invention was described with reference to two embodiments. Those skilled in the art will appreciate that changes and modifications of the invention can be made without departing from the scope of protection of the following claims.

### LIST OF REFERENCE CHARACTERS

No. Name
1 Apparatus
3 Melt
4 Electrode
5 Phase conductor
6 Furnace transformer
6P Primary side
6S Secondary side
7 Line, phase
9 Power supply network
10 Electric arc furnace
11 Furnace vessel
12 Outer wall
13 Inner wall
15 Sensor type (thermal)
16 Sensor type (structure-borne sound)
17 Sensor type (radiation)
20 On-load tap changer, semiconductor tap changer
22 Overall regulation
24 Thermally based power regulation
26 Over current regulation
28 Flicker regulation
30 Control and regulating unit
31 First step
32 Second step
33 Third step
Pₘₐₓ Maximum power
Pₘᵢₙ Maximum power
P Active power
T_{S1} . . . T_{SN} Winding tap, transformer stage
S₁ . . . S_{N} Semiconductor switching component

1. An apparatus for process-based power regulation of an electric arc furnace, the apparatus comprising:
a plurality of sensor types for detecting presently active operating parameters of the electric arc furnace in dependence on time;
a control and regulating unit;
at least one furnace transformer with a primary side and a secondary side;
at least one semiconductor on-load tap changer that switches winding taps of the primary side of the furnace transformer; and
three electrodes electrically connected with the secondary side of the at least one furnace transformer and each define one line.

2. The apparatus according to claim 1, further comprising:
a respective furnace transformer connected to each electrode and having a primary side with winding taps each switchable by the semiconductor tap changer and a secondary side connected with the electrodes.

3. The apparatus according to claim 1 wherein the sensor types are thermal sensors or optical sensors or acoustic sensors that are connected with the control and regulating unit.

4. The apparatus according to claim 1, wherein the control and regulating unit is communicatively connected with the semiconductor tap changer such that the presently applied phase voltages between consecutive lines 7 are regulatable in dependence on the measurements from the sensor types and in comparison with a set point.

5. A method for thermally based power regulation of an electric arc furnace, the method comprising the steps of:
detecting with a plurality of sensor types the presently active operating parameters of the electric arc furnace;
transmitting the detected parameters to a control and regulating unit;
determining with the unit a criticality value; and
in dependence on the value of the determined criticality, influencing a switching of winding taps at a primary side of at least one furnace transformer at least one semiconductor tap changer in such a manner that the state of the electric arc furnace is kept in an uncritical operating state or brought into an uncritical operating state.

6. The method according to claim 5 wherein
the electric arc furnace has three electrodes, by means of which thermal energy is input into the electric arc furnace,
the electrodes are connected with a secondary side of the furnace transformer,
each electrode together with a phase conductor, forms a line, and
the method further comprises the step of applying a modified phase voltage to the three lines via the switching of the winding taps on the primary side of the furnace transformer such that electric arcs emitting from the electrodes are symmetrically supplied with a required amount of electrical energy so that the state of the electric arc furnace is kept in an uncritical operating state or brought into an uncritical operating state.

7. The method according to claim 6, further comprising the steps of:
applying asymmetrical phase voltages to the phase conductors of the electrodes by the semiconductor tap changer,
asymmetrically supplying electric arcs emitting from the electrodes with a required amount of electrical energy so that the state of the electric arc furnace is kept in an uncritical operating state or brought into an to uncritical operating state.

8. The method according to claim 7 wherein the phase voltages applied between the three lines and thus the active power typically differ by up to 10% in terms of amount.

9. The method according to claim 5 wherein
the electric arc furnace has three electrodes, by means of which thermal energy is input into the electric arc furnace, and
each of the electrodes is connected with a secondary side of a furnace transformer assigned to it, and
the method further comprising the step of feeding the electrodes with a corresponding amount of electrical energy via the switching of the winding taps on the primary side of the respective furnace transformer so that the state of the electric arc furnace is kept in an uncritical operating state or brought into an uncritical operating state, wherein each of the three lines is controllable independently of the other lines of the electric arc furnace.

10. The method according to claim 5, further comprising the step of:
calculating the criticality value from operating parameters of the electric arc furnace composed of the thermal state of a furnace vessel of the electric arc furnace or an optical detection of burning electric arcs or the sound or structure-borne sound emitted from the electric arc furnace.
